(19) United States
(12) Patent Application Publication
(10) Pub. No.: US 2013/0323520 A1
(43) Pub. Date: Dec. 5, 2013

(54) Polymeric Film Assemblies With Improved Resistance to Smudges, Related Articles and Methods

(71) Applicant: James E. McGuire, JR., Westerville, OH (US)

(72) Inventor: James E. McGuire, JR., Westerville, OH (US)

(21) Appl. No.: 13/981,591

(22) PCT Filed: Feb. 1, 2012
(86) PCT No.: PCT/US12/23415

§ 371 Date: Jul. 24, 2013

Related U.S. Application Data
(60) Provisional application No. 61/439,126, filed on Feb. 3, 2011.

(51) Int. Cl. C08K 3/34; C09J 7/02; B32B 7/12; B32B 27/20

(52) U.S. Cl. CPC C08K 3/346; B32B 27/20; C09J 7/0264; B32B 7/12
USPC 428/454; 428/425.5; 428/343; 428/41.8; 156/60; 428/331; 524/445

(57) ABSTRACT

A polymeric film assembly for application to at least one surface of an article comprises a polymeric film comprising an exterior surface, wherein the polymeric film comprises at least one clay in an anti-smudge effective amount, and wherein the polymeric film is essentially free of low surface energy components. A method for application of a polymeric film to at least one surface of an electronic device is also disclosed.

### BACKGROUND OF THE INVENTION

The present invention relates to polymeric film assemblies, which can be applied to a variety of articles and provide improved smudge resistance, as well as related articles and methods.

Polymeric films are applied to surfaces of articles for a number of reasons. One significant application for polymeric films is for providing a protective covering on an article's surface. For example, certain polymeric films are capable of protecting an article's surface from damage during use of the article. Such protective polymeric films are often adhered to an article's surface to minimize damage thereto.

Applications for protective and other polymeric films are becoming increasingly desirable as widespread use of consumer electronic devices soars. Many consumer electronic devices employ a display that can easily be scratched, cracked, or otherwise damaged. For example, most personal data assistants, cellular phones, tablet computers, laptop computers, and notebook computers, and similar devices include a display for viewing data and/or images thereon. In order to optimize viewing efficiency, such displays are highly engineered to maximize clarity of data and images viewed thereon. Unfortunately, however, such displays are often prone to scratching, cracking, or other types of damage, especially as users of such electronic devices tote the devices haphazardly through their daily lives.

Conventionally, when protective polymeric films are applied to surfaces of electronic devices, the goal is to provide a protective covering on the display or other surface of the device that does not significantly diminish desired qualities of the underlying surface. Importantly, when a protective polymeric film is applied to a display, the film is selected to have desired optical clarity. Then, when the polymeric film is applied to the display, it is important to maintain desired optical clarity of the film as well as views of the display therethrough. With use, smudges from dirt and oils and sometimes fog or other moisture, continually challenge such clarity. With the rapidly increasing number of consumer electronic devices promoting touch screens for their control, smudge control has taken on a new meaning in its focus on problematic fingerprint smudges.

In an attempt to improve smudge resistance of such polymeric films, most methodologies rely on incorporation of low surface energy components to provide oleophobic properties to the polymeric film. Examples of such components include those relying on silicone and fluorine constituents, such as those described in U.S. Patent Publication No. 2008/0265387 and U.S. Pat. No. 7,763,678.

Nevertheless, conventional methodologies have yet to provide adequate resistance to smudges arising from fingerprints specifically, which are of continual frustration to many in their daily use of tablet computers (e.g., the iPad, Kindle Fire, and the like) and other consumer electronic devices employing touch displays. Due to the failure of conventional polymeric film coverings to provide adequate resistance to fingerprint smudges, users of such devices often result to constant cleaning of such surfaces with specialized cloths and sprays.

It is desirable to provide alternative assemblies and methods for application of polymeric films to surfaces of articles. Particularly desirable are alternative assemblies having improved smudge resistance—e.g., resistance to fingerprint smudges—and related methods for their application.

### SUMMARY OF THE INVENTION

A polymeric film assembly for application to at least one surface of an article comprises a polymeric film comprising an exterior surface, wherein the polymeric film comprises at least one clay in an anti-smudge effective amount, and wherein the polymeric film is essentially free of low surface energy components. An article comprising the assembly adhered to at least a portion of at least one surface thereof is also disclosed herein.

In an exemplary embodiment, the polymeric film is hydrophilic. According to one embodiment, the polymeric film comprises a carrier layer and a topcoat layer, each comprising the same or different chemistry. According to one aspect of the invention, the carrier layer is polyurethane-based. According to another aspect of the invention, the topcoat layer is polyurethane-based. In one embodiment, the assembly is essentially transparent. In another embodiment, the assembly is essentially translucent.

According to a further embodiment, the assembly comprises an adhesive layer adhered to an adhesion surface of the polymeric film. According to yet a further embodiment, the assembly comprises a release liner adhered to the adhesive layer opposite the polymeric film. According to yet a further embodiment, the assembly comprises a protective liner adjacent to the exterior surface of the polymeric film. According to still a further embodiment, the assembly comprises an application film adjacent to an opposite surface of the protective liner as that surface of the protective liner in contact with the exterior surface of the polymeric film.

Any suitable clay may be present in assemblies of the invention. In one embodiment, the at least one clay comprises a nanoclay. An exemplary clay comprises an aluminum silicate clay. In one embodiment, an anti-smudge effective amount of the clay is present such that the polymeric film comprises about 2% to about 8% by weight clay based on total weight of the polymeric film composition.

The assembly may be adapted such that it comprises a shape compatible with the surface of the article. For example, the surface of the article with which the shape of the assembly is compatible comprises a touch screen display of a consumer electronic device in one embodiment. An exemplary consumer electronic device comprises a tablet computer.

A method for application of a polymeric film to at least one surface of an electronic device is also disclosed. For example, a method for application of a polymeric film to at least one surface of an electronic device comprises: providing a polymeric film assembly to be applied to the surface, wherein the polymeric film assembly comprises an outwardly exposed adhesive layer; and positioning the adhesive layer of the polymeric film assembly on the surface of the electronic device. In an exemplary application, the surface of the electronic device comprises a touch screen display of a tablet computer.

### BRIEF DESCRIPTION OF THE SEVERAL VIEWS OF THE DRAWINGS

FIG. 1A is a cross-sectional view of one embodiment of a polymeric film assembly of the invention.

FIG. 1B is a cross-sectional view of the polymeric film assembly of FIG. 1A, illustrating a further embodiment of the polymeric film therein.

FIG. 1C is a cross-sectional view of a further embodiment of the polymeric film assembly of FIG. 1A, wherein the polymeric film assembly further comprises a release liner.

FIG. 1D is a cross-sectional view of a further embodiment of the polymeric film assembly of FIG. 1A, wherein the polymeric film assembly further comprises a protective liner.

FIG. 1E is a cross-sectional view of a further embodiment of the polymeric film assembly of FIG. 1D, wherein the polymeric film assembly further comprises an application film.

FIG. 1F is a cross-sectional view of the carrier layer within the polymeric film of the polymeric film assembly of FIG. 1B.

### DETAILED DESCRIPTION OF THE INVENTION

Polymeric film assemblies according to the invention are capable of providing functionality that is, for example, protective, decorative, reflective, anti-reflective, fog-resistant, and/or for privacy. In any event, all polymeric film assemblies of the invention advantageously have improved smudge resistance—e.g., resistance to fingerprint smudges—as compared to conventional polymeric film assemblies. Such assemblies may be applied to at least a portion of one or more surfaces of an article, such as surfaces on which data and/or images are visible (e.g., the surface of a monitor or screen). When configured for application to a surface on which data and/or images are to be viewed, a polymeric film assembly of the present invention may be transparent. Polymeric film assemblies configured for application to other surfaces, including surfaces through which data and/or images need not be clearly viewed, may be, for example, not only transparent, but also translucent or opaque. In further embodiments, polymeric film assemblies of the invention include one or more decorative features that enhance the look of a surface onto which they are to be applied.

In one embodiment, polymeric film assemblies can be effectively applied to one or more surfaces of an article, such as an electronic device. The invention is applicable to any of a number of articles, electronic or otherwise, such as, for example, consumer electronic devices. Exemplary embodiments of the invention include those applicable to consumer electronic devices, such as personal data assistants, cellular phones, personal computers (e.g., tablet, laptop, and notebook computers), and similar devices that include a display for viewing data and/or images thereon. According to an exemplary embodiment, the consumer electronic device comprises a touch screen display for control of the device. Such displays are particularly prone to problematic fingerprint smudges. According to other embodiments, polymeric film assemblies of the invention are applied to other types of surfaces that may benefit, aesthetically or otherwise, from a protective film covering.

In one embodiment, a polymeric film assembly of the invention is configured to adhere to a surface of an article via an adhesion surface. According to this embodiment, an adhesion surface of a polymeric film assembly is at least partially coated with an adhesive (e.g., a pressure-sensitive adhesive). In a further embodiment, the assembly comprises a release liner adjacent to the adhesion surface. Opposite the adhesion surface, the polymeric film assembly includes an exterior surface that is substantially free of adhesive.

In an exemplary embodiment, a polymeric film assembly of the invention is configured to be applied to a surface to be protected using a pressure-sensitive adhesive in a “dry install” method as described in U.S. Provisional Patent Application No. 61/358,387, and PCT Patent Publication No. WO 2011/163151 claiming priority therefrom, entitled “Assembly, Kit, and Related Method for Applying a Polymeric Film to a Device,” and incorporated by reference in its entirety herein. Thus, according to a further embodiment, the assembly comprises a protective liner adjacent to the exterior surface of the polymeric film that is substantially free of adhesive and which is capable of protecting the polymeric film as it is applied to a surface of an article using, for example, a “dry install” method. According to yet a further embodiment, the assembly comprises an application film adjacent to an opposite surface of the protective liner as that surface of the protective liner in contact with the exterior surface of the polymeric film that is substantially free of adhesive.

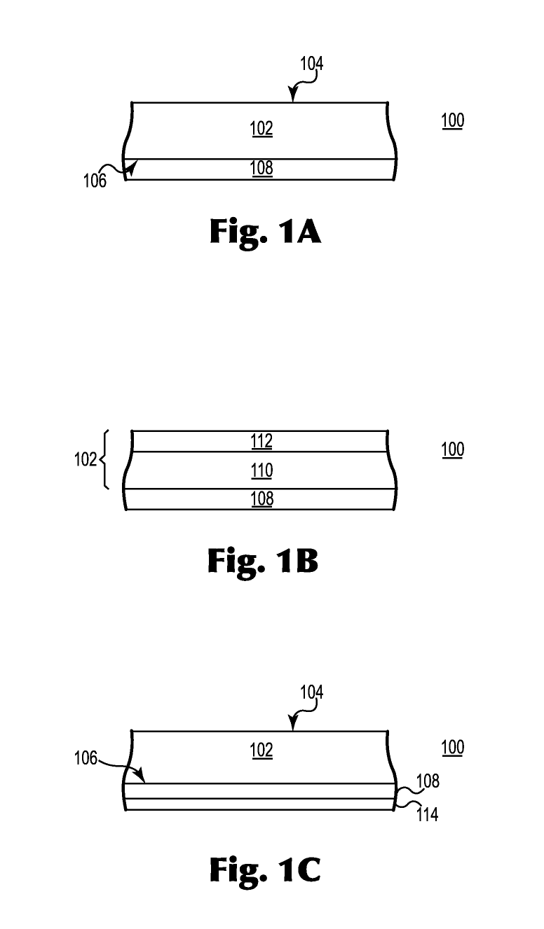

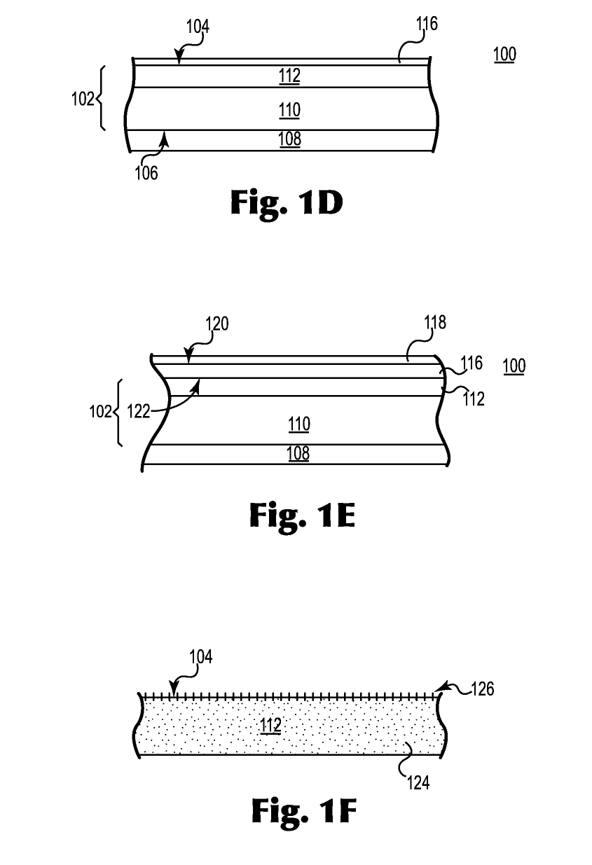

FIG. 1A illustrates one embodiment of a polymeric film assembly 100 of the invention. The polymeric film assembly 100 includes a polymeric film 102 with an exterior surface 104 that is substantially free of adhesive and an opposite adhesion surface 106 configured to be secured to at least one surface of an article. The adhesion surface 106 carries an adhesive layer 108, which enables the polymeric film 102 to be secured to the surface of the article.

The polymeric film 102 comprises at least one clay in an anti-smudge effective amount—e.g., an amount to prevent smudging of the polymeric film 102 upon firmly touching the same with ones finger, which smudging would be visible to an unaided human eye. According to a further embodiment illustrated in FIG. 1B, the polymeric film 102 of FIG. 1A comprises a carrier layer 110 and a topcoat layer 112, wherein the topcoat layer 112 comprises the at least one clay in an anti-smudge effective amount.

As illustrated in FIG. 1C, in a further embodiment of the polymeric film assembly 100 shown in FIG. 1A, the polymeric film assembly 100 comprises a release liner 114 adhered to the adhesive layer 108 opposite the polymeric film 102. Opposite the adhesion surface 106, the polymeric film assembly 100 includes an exterior surface 104 that is substantially free of adhesive.

As illustrated in FIG. 1D, in another further embodiment of the polymeric film assembly 100 shown in FIG. 1A, the polymeric film assembly 100 comprises a protective liner 116 adjacent to the exterior surface 104 of the polymeric film 102 that is substantially free of adhesive and which is capable of protecting the polymeric film 102 as it is applied to a surface of an article using, for example, a “dry install” method.

As illustrated in FIG. 1E, according to yet a further embodiment of the polymeric film assembly 100 shown in FIG. 1D, the polymeric film assembly 100 comprises an application film 118 adjacent to an opposite surface 120 of the protective liner 116 as that surface 122 of the protective liner 116 in contact with the exterior surface 104 of the polymeric film 102 that is substantially free of adhesive.

FIG. 1F provides a detailed view of clay 124 within the topcoat layer 112 of the polymeric film assembly 100 illustrated in FIG. 1B. As illustrated therein, the clay 124 is uniformly dispersed throughout the topcoat layer 112, but concentrated on the exterior surface 104 thereof in an aligned layer 126. While not wishing to be bound by theory, it is believed that the improved anti-smudge properties arise from the aligned layer 126 comprising clay 124 oriented in substantially the same longitudinal direction with respect to the topcoat layer 112. For example, due to this orientation, contact with the exterior surface 104 of the polymeric film assembly 100 in an amount to significantly fingerprint the surface 104 is prevented by the physical surface structure.

In one embodiment, the polymeric film assembly 100 is translucent or opaque. In another embodiment, the polymeric film assembly 100 is transparent. Preferably, when the surface on which it is applied is an optical display, the polymeric film assembly 100 is translucent or, more preferably, transparent.

In all embodiments, the polymeric film 102 comprises any suitable chemistry. The polymeric film 102 may comprise one or multiple layers. In an exemplary embodiment, the polymeric film 102 comprises a carrier layer 110 and a topcoat layer 112 as illustrated in FIG. 1B. Each of the carrier layer 110 and the topcoat layer 112 can have the same or different base chemistry. For example, but for the addition of the clay 124 in accordance with the present invention, the carrier layer 110 and topcoat layer 112 can be those described in U.S. Patent Publication No. US-2008-0286576, entitled “Protective Sheets, Articles, and Methods,” incorporated by reference herein in its entirety.

Suitable base polymers include, for example, polyvinyl chloride, polyvinyl acetate, polypropylene, polyester, poly(meth)acrylate, polyethylene, polyurethane, one of a number of rubbery resins (e.g., silicone elastomers), and combinations thereof. A number of polyurethane films are known to provide a particularly desirable combination of protective and optical properties. For simplicity, the term “polyurethane” as used herein includes polymers containing urethane (also known as carbamate) linkages, urea linkages, or combinations thereof (i.e., in the case of poly(urethane-urea)s). Thus, polyurethanes are understood herein to contain at least urethane linkages and, optionally, urea linkages. In one embodiment, polyurethane-based layers are based on polyurethanes where the backbone has at least about 80% urethane and/or urea repeat linkages formed during their polymerization. Polyurethane chemistry is well known to those of ordinary skill in the art.

Many commercially available polyurethanes are available and suitable for use in polymeric films 102 according to the invention. Commercial vendors include Huntsman Corporation of Auburn Hills, Mich. (which sells polyurethanes under the KRYSTALFLEX trade designation); Bayer MaterialScience LLC of Pittsburgh, Pa. (which sells polyurethanes under the DURAFLEX trade designation); Argotec; American Polyfilm Inc. of Branford, Conn.; Stevens Urethane of Easthampton, Mass.; and others. For example, polyurethanes are available from Thermedics (Noveon, Inc.) of Wilmington, Mass., under the TECOFLEX trade designation (e.g., CLA-93AV) and from Bayer MaterialScience LLC of Pittsburgh, Pa., under the TEXIN trade designation (e.g., an aliphatic ester-based polyurethane suitable as a base polymer for polymeric films 102 of the invention is available under the trade designation, TEXIN DP7-3008). Stevens Urethane of Easthampton, Mass., as another example, markets such polyurethane films as extrudable aliphatic polyurethanes designated SS-1219-92 and SS-2219-92.

The polymeric film 102 has any suitable thickness. In the case of the multilayer polymeric film 102 embodiment illustrated in FIG. 1B, each of the carrier layer 110 and the topcoat layer 112 of the polymeric film 102 has any suitable thickness. In one embodiment, the carrier layer 110 has a thickness of about 25 microns to about 150 microns. In a further embodiment, the carrier layer 110 has a thickness of about 50 microns to about 100 microns. In one embodiment, the topcoat layer 112 has a thickness of about 3 microns to about 50 microns. In a further embodiment, the topcoat layer 112 has a thickness of about 4 microns to about 8 microns. However, thickness of each of the carrier layer 110 and the topcoat layer 112 or other layers constituting the polymeric film 102 can vary substantially without departing from the spirit and scope of the invention.

While an adhesive layer 108 is not required, according to one embodiment of the polymeric film assembly 100, the polymeric film 102 comprises an adhesive layer 108 on an adhesion surface 106 thereof. In a preferred embodiment, the adhesive layer 108 comprises a pressure-sensitive adhesive. According to another embodiment, the adhesive layer 108 comprises a heat-activated adhesive.

While any suitable chemistry can be used for the base polymer in the adhesive layer 108, (meth)acrylate—i.e., acrylate and/or methacrylate—chemistry is preferred. However, other suitable chemistries are known to those skilled in the art and include, for example, those based on synthetic and natural rubbers, polybutadiene and copolymers thereof, polyisoprene or copolymers thereof, and silicones (e.g., polydimethylsiloxane and polymethylphenylsiloxane). In particular, an adhesive based on 2-ethyl hexyl acrylate, vinyl acetate, and acrylic acid monomers polymerized as known to those skilled in the art was found useful in one embodiment of the invention. In an exemplary embodiment, the adhesive comprises that available from entrochem, inc. of Columbus, Ohio, under the “entrochem eca-340” trade designation.

In one embodiment, the adhesive layer 108 has a thickness of about 5 microns to about 150 microns. In a further embodiment, the adhesive layer 108 has a thickness of about 30 microns to about 100 microns. However, the thickness of the adhesive layer 108 can vary substantially without departing from the spirit and scope of the invention.

Any suitable additives can be present in the polymeric film assembly 100 and individual layers thereof as known to those skilled in the art and based on the intended application. In one embodiment, the adhesive layer 108 is crosslinked, for example, using conventional aluminum or melamine crosslinkers. In another embodiment, the topcoat layer 112 is crosslinked. Those skilled in the art are readily able to determine the amount of such additives to use for the desired effect.

While other layers of the polymeric film assembly 100 may comprise clay 124, at least the outermost layer (e.g., the topcoat layer 112) of the polymeric film assembly 100 comprises at least one clay 124 according to the invention. Any suitable clay 124 can be used to impart anti-smudge properties to the polymeric film assembly 100.

The clay 124 may be functionalized or non-functionalized. In an exemplary embodiment, the clay 124 and other components of the polymeric film 102 are essentially free of low surface energy functionality. As discussed above, low surface energy materials have proven ineffective at providing displays with desired resistance to smudges (e.g., fingerprint smudges). Further, low surface energy materials tend to be hydrophobic. Hydrophobic materials often cause beading of water-based materials on surfaces thereof. Such beading tends to be slow to evaporate due to the comparatively lower surface area and hydrogen bonding associated therewith. In contrast, preferred polymeric films 102 of the invention are oleophilic, and even hydrophilic, in further embodiments.

Generally, the clay 124 has an average particle diameter (i.e., maximum cross-sectional dimension) of about 20 micrometers or less. In a preferred embodiment, the clay 124 comprises nanoscale dimensions (i.e., the clay 124 is a nanoclay). A nanoclay as used herein is understood to have nanoscale dimensions, wherein average particle diameter of the clay is no more than about 500 nanometers. In one embodiment, the nanoclay has an average particle diameter of no more than about 100 nanometers. In a further embodiment, the nanoclay has an average particle diameter of no more than about 10 nanometers. In yet a further embodiment, the nanoclay has an average particle diameter of no more than about 1 nanometer. In yet a further embodiment still, the nanoclay has an average particle diameter of no more than about 0.1 nanometer. While minimizing maximum particle diameter thereof is a consideration, nanoclay according to the invention has an average particle diameter greater than 50 nanometers according to an exemplary embodiment.

Exemplary clays include kaolinite, montmorillonite-smectite, illite, and chlorite clays. For example, a suitable clay for use according to the invention is an aluminum silicate clay. A variety of clays are commercially available, including those nanoclays available from Southern Clay Products, Inc. (Gonzales, Tex.) under the CLOISITE trade designation.

The polymeric film 102 comprises an anti-smudge effective amount of at least one clay 124. The amount of clay 124 may also be selected based on desired light transmission, if desired. For example, in one embodiment, the amount of clay 124 is selected to achieve a visible light transmittance of about 80% in the polymeric film assembly 100.

In one embodiment, the polymeric film 102 comprises about 2% to about 8% by weight clay 124 based on total weight of the polymeric film composition. In an exemplary embodiment, the polymeric film 102 comprises about 6% by weight clay 124 based on total weight of the polymeric film composition.

The clay 124 is added to other components of the polymeric film 102, or at least the outermost layer therein, using any suitable method. For example, in one embodiment, the clay 124 is dispersed within other components of the topcoat layer 112 using high shear mixing as known to those of ordinary skill in the art. Preferably, the clay 124 is uniformly dispersed within the polymeric film 102 or outermost layer therein. Suitable clays 124 are preferably compatible with the other components of the polymeric film 102 in which they are dispersed such that essentially no agglomeration of the clay 124 results in the polymeric film assembly 100 upon dispersion.

Articles comprising polymeric film assemblies 100 of the present invention have improved anti-smudge properties, particularly resistance to fingerprint smudges. In one embodiment, smudges that do appear on the polymeric film assembly 100 can be quickly and easily removed with no more than a wipe of one's hand. Expensive wipes and sprays are not needed to remove most smudges, including bothersome fingerprint smudges plaguing the tablet computer and similar consumer electronic device users.

Various modifications and alterations of the invention will become apparent to those skilled in the art without departing from the spirit and scope of the invention. The lack of mention or discussion of a feature, step, or component provides the basis for claims where the absent feature or component is excluded by way of a proviso or similar claim language.

Further, as used throughout, ranges may be used as shorthand for describing each and every value that is within the range. Any value within the range can be selected as the terminus of the range. Similarly, any discrete value within the range can be selected as the minimum or maximum value recited in describing and claiming features of the invention.

In addition, as discussed herein it is again noted that the composition described herein may comprise all components in one or multiple parts. Other variations are recognizable to those of ordinary skill in the art.

1. A polymeric film assembly for application to at least one surface of an article, the assembly comprising:
a polymeric film comprising an exterior surface,
wherein the polymeric film comprises at least one clay in an anti-smudge effective amount, and
wherein the polymeric film is essentially free of low surface energy components.

2. The assembly of claim 1, wherein the polymeric film comprises a carrier layer and a topcoat layer.

3. The assembly of claim 2, wherein the carrier layer is polyurethane-based.

4. The assembly of claim 2, wherein the topcoat layer is polyurethane-based.

5. The assembly of claim 1, further comprising an adhesive layer adhered to an adhesion surface of the polymeric film.

6. The assembly of claim 5, further comprising a release liner adhered to the adhesive layer opposite the polymeric film.

7. The assembly of claim 1, further comprising a protective liner adjacent to the exterior surface of the polymeric film.

8. The assembly of claim 7, further comprising an application film adjacent to an opposite surface of the protective liner as that surface of the protective liner in contact with the exterior surface of the polymeric film.

9. The assembly of claim 1, wherein the at least one clay comprises a nanoclay.

10. The assembly of claim 1, wherein the at least one clay comprises an aluminum silicate clay.

11. The assembly of claim 1, wherein the polymeric film comprises about 2% to about 8% by weight clay based on total weight of the polymeric film composition.

12. The assembly of claim 1, wherein the polymeric film is hydrophilic.

13. The assembly of claim 1, wherein the assembly comprises a shape compatible with the surface of the article.

14. The assembly of claim 1, wherein the surface of the article with which the shape of the assembly is compatible comprises a touch screen display of a consumer electronic device.

15. (canceled)

16. The assembly of claim 1, wherein the assembly is essentially transparent.

17. The assembly of claim 1, wherein the assembly is essentially translucent.

18. An article comprising the assembly of claim 1 adhered to at least a portion of at least one surface thereof.

19. A method for application of a polymeric film to at least one surface of an electronic device, the method comprising:
providing the polymeric film assembly of claim 1 to be applied to the surface, wherein the polymeric film assembly comprises an outwardly exposed adhesive layer; and
positioning the adhesive layer of the polymeric film assembly on the surface of the electronic device.

20. The method of claim 19, wherein the surface of the electronic device comprises a touch screen display.

21. The assembly of claim 9, wherein the nanoclay has an average particle diameter of no more than about 100 nanometers.

22. The assembly of claim 2, wherein the clay is uniformly dispersed throughout the topcoat layer, but concentrated on an exterior surface thereof in an aligned layer oriented in substantially the same longitudinal direction with respect to the topcoat layer.
